(19) United States
(12) Patent Application Publication
(10) Pub. No.: US 2009/0040120 A1
(43) Pub. Date: Feb. 12, 2009

(54) ANTENNA STRUCTURE AND RADIO COMMUNICATION DEVICE USING THE SAME

(75) Inventors: Nobuhito Tsubaki, Sagamihara-shi (JP); Kenichi Ishizuka, Yokohama-shi (JP); Kazunari Kawahata, Yokohama-shi (JP)

Correspondence Address: OSTROLENK FABER GERB & SOFFEN, 1180 AVENUE OF THE AMERICAS, NEW YORK, NY, 100368403, US

(73) Assignee: Murata Manufacturing Co., Ltd.

(21) Appl. No.: 12/261,744

(22) Filed: Oct. 30, 2008

Related U.S. Application Data
(63) Continuation of application No. PCT/JP2007/066196, filed on Aug. 21, 2007.

(30) Foreign Application Priority Data
Sep. 20, 2006 (JP) 2006-254565
Mar. 2, 2007 (JP) 2007-053077

(51) Int. Cl. H01Q 1/24; H01Q 1/38

(52) U.S. Cl. 343/702; 343/700 MS

(57) ABSTRACT

A radiation electrode is formed on a substrate of a surface mount antenna. One end of the radiation electrode forms a ground connection portion connected to ground, and the other end of the radiation electrode forms an open end. A ground connection electrode for connecting the open end of the radiation electrode to ground via a capacitance is provided on the substrate. No feeding electrode for feeding power to the radiation electrode is provided on the substrate. This surface mount antenna is mounted on a non-ground region (a region on which a ground electrode is not formed) of a board so as to constitute an antenna structure. On the board of the antenna structure, a feeding electrode for capacitively feeding power to the radiation electrode is provided at a position between the ground connection portion and the open end.

### CROSS-REFERENCE TO RELATED APPLICATIONS

This is a continuation under 35 U.S.C. §111(a) of PCT/JP2007/066196 filed Aug. 21, 2007, and claims priority of JP2006-254565 filed Sep. 20, 2006, and JP2007-053077, filed Mar. 2, 2007, incorporated by reference.

### BACKGROUND

1. Technical Field

The present disclosure relates to an antenna structure for use in a radio communication device such as a mobile phone and to a radio communication device using the antenna structure.

2. Background Art

FIG. 8 illustrates an example of a configuration of a conventional surface mount antenna by a schematic perspective view (for example, see Patent Document 1). This surface mount antenna 30 has a dielectric substrate 31. A radiation electrode 32 is formed on the dielectric substrate 31. In addition, a feeding electrode 33 and a ground connection electrode 34 are formed on the dielectric substrate 31. The radiation electrode 32 has a predetermined resonant frequency to perform antenna operations for radio communication. One end 32a of the radiation electrode 32 is connected to ground. The other end 32b of the radiation electrode 32 is an open end. The feeding electrode 33 is capacitively coupled with the radiation electrode 32 to capacitively feed the radiation electrode 32. The ground connection electrode 34 is capacitively coupled with the open end 32b of the radiation electrode 32 to connect the open end 32b of the radiation electrode 32 to ground.

The surface mount antenna 30 is mounted on a circuit board 36 of, for example, a radio communication device to operate. This circuit board 36 is provided with a ground region Zg and a non-ground region Zf. The ground region Zg is a region in which a ground electrode 37 is formed. The non-ground region Zf is a region in which the ground electrode 37 is not formed. The surface mount antenna 30 is mounted at a predetermined setting position in the non-ground region Zf of the circuit board 36. Thus, the surface mount antenna 30 is mounted on the predetermined setting position of the circuit board 36, so that the one end 32a of the radiation electrode 32 of the surface mount antenna 30 is electrically connected to the ground electrode 37 on the circuit board 36 so as to be grounded. In addition, the ground connection electrode 34 is also electrically connected to the ground electrode 37 on the circuit board 36. This causes the open end 32b of the radiation electrode 32 to be connected to ground by the ground connection electrode 34 via a capacitance. Further, the feeding electrode 33 of the surface mount antenna 30 is connected to, for example, a high-frequency circuit 38 for radio communication which is formed on the circuit board 36.

In the surface mount antenna 30 configured as described above, a resonant frequency of the radiation electrode 32 is determined by the length from the end portion 32a for ground connection to the open end 32b of the radiation electrode 32 and the amount of capacitance between the open end 32b of the radiation electrode 32 and the ground connection electrode 34. In addition, a matching state between the radiation electrode 32 and the high-frequency circuit 38 for radio communication is determined by the overall length of the feeding electrode 33 and the position of the feeding electrode 33.

FIG. 9a illustrates another example of a configuration of a surface mount antenna by a schematic perspective view (for example, see Patent Document 2). This surface mount antenna 40 has a dielectric substrate 41. A radiation electrode 42 and a feeding electrode 43 are formed on the dielectric substrate 41. The radiation electrode 42 performs antenna operations. One end 42a of this radiation electrode 42 is connected to ground. The other end 42b of the radiation electrode 42 is an open end. The feeding electrode 43 is formed so as to be capacitively coupled with the open end 42b of the radiation electrode 42 to capacitively feed the radiation electrode 42.

This surface mount antenna 40 is mounted at a predetermined setting position in a non-ground region Zf of a circuit board 45, as illustrated in FIG. 9a. The surface mount antenna 40 is mounted at the setting position on the circuit board 45, so that the one end 42a of the radiation electrode 42 of the surface mount antenna 40 is electrically connected to a ground electrode 46 on the circuit board 45 to be grounded. In addition, the feeding electrode 43 is electrically connected to a high-frequency circuit 47. The high-frequency circuit 47 is a circuit for radio communication which is formed on the circuit board 45.

In the surface mount antenna 40 configured as described above, a resonant frequency of the radiation electrode 42 is determined by the amount of capacitance between the feeding electrode 43 and the open end 42b of the radiation electrode 42 and the length from the end portion 42a for ground connection of the radiation electrode 42 to the open end 42b.

Patent Document 1: Japanese Unexamined Patent Application Publication No. H10-13139

Patent Document 2: Japanese Unexamined Patent Application Publication No. 2004-165965

In the configuration of the surface mount antenna 30 in FIG. 8, the feeding section of the radiation electrode 32 (i.e., the section from which the feeding electrode 33 feeds power to the radiation electrode 32) is located between the one end 32a and the open end 32b of the radiation electrode 32. The feeding section of the radiation electrode 32 is disposed on a section that provides satisfactory matching between the radiation electrode 32 and the high-frequency circuit 38 for radio communication. That is, the feeding electrode 33 is formed on the section providing satisfactory matching between the radiation electrode 32 and the high-frequency circuit 38 for radio communication so as to capacitively feed power to the radiation electrode 32.

Such a configuration has several disadvantages. Specifically, when the circuit configuration of the high-frequency circuit 38 varies due to, for example, a difference in the model of a radio communication device, the position of the section in the radiation electrode 32 which provides satisfactory matching with the high-frequency circuit 38 also varies. Thus, for the surface mount antenna 30, it is necessary to change the position of the feeding electrode 33 with respect to the radiation electrode 32 for individual models of radio communication device, for example, so as to achieve satisfactory matching between the radiation electrode 32 and the high-frequency circuit 38. That is, the surface mount antenna 30 is designed for each model of radio communication device to serve as an antenna dedicated to that model. Thus, shared use of the surface mount antenna 30 is difficult.

On the other hand, the surface mount antenna 40 illustrated in FIG. 9a has a configuration in which the feeding electrode 43 feeds power to the open end 42b of the radiation electrode 42. Therefore, satisfactory matching between the radiation electrode 42 and the high-frequency circuit 47 can be achieved without changing the position of the feeding electrode 43. That is, in the surface mount antenna 40, satisfactory matching between the radiation electrode 42 and the high-frequency circuit 47 can be achieved by providing a matching circuit suitable for the matching state between the radiation electrode 42 and the high-frequency circuit 47 on the circuit board 45. Thus, shared use of the surface mount antenna 40 can readily be achieved. Accordingly, the surface mount antenna 40 permits cost reduction. In addition, the surface mount antenna 40 can easily be modified to be compatible with a design change or the like of a radio communication device.

However, with the surface mount antenna 40, the following problems are likely to occur. In the configuration of the surface mount antenna 40, the part in the radiation electrode 42 where the intensity of an electric field is maximized is the open-end 42b, which is capacitively coupled with the feeding electrode 43. The surface mount antenna 40 having such a configuration has an equivalent circuit illustrated in FIG. 9b. The resonant frequency of the radiation electrode 42 is mainly determined in relation to an inductance value of the radiation electrode 42 and a capacitance between the radiation electrode 42 and the feeding electrode 43. However, the radiation electrode 42 of the surface mount antenna 40 is likely to generate a capacitance (stray capacitance) Cb indicated by dotted lines in FIG. 9b between the radiation electrode 42 and the ground electrode 46 or a peripheral component recognized as ground. The stray capacitance Cb adversely affects the resonant frequency of the radiation electrode 42, which leads to a problem of deterioration of antenna characteristics.

### SUMMARY

In the present disclosure, a configuration described below provides means for solving the problems. Specifically, an antenna structure may include a surface mount antenna having a configuration with a radiation electrode performing an antenna operation formed on a substrate, and a board having a ground region having a ground electrode formed thereon and a non-ground region not having the ground region formed thereon. The antenna structure has a configuration in which the surface mount antenna is mounted on the non-ground region on the board, in which one end of the radiation electrode of the surface mount antenna forms a ground connection portion to be grounded to the ground electrode of the board and the other end of the radiation electrode forms an open end, and the radiation electrode has a feeding section capacitively fed with power at a position between the ground connection portion and the open end, in which a ground connection electrode capacitively coupled with the open end of the radiation electrode to electrically connect the open end of the radiation electrode to the ground electrode of the board via a capacitance is formed on the substrate of the surface mount antenna. A feeding electrode for capacitively feeding power to the feeding section of the radiation electrode of the surface mount antenna is formed on the board at a position between the ground connection portion and the open end.

A radio communication device according to the present disclosure is provided with an antenna structure having a configuration described herein, and a high frequency circuit for radio communication.

According to the present disclosure, one end of a radiation electrode formed on a substrate of a surface mount antenna forms a ground connection portion and the other end of the radiation electrode forms an open end. In addition, a ground connection electrode for connecting the open end of the radiation electrode to ground is formed on the substrate of the surface mount antenna. The open end of the radiation electrode is a section where the intensity of an electric field is maximized and is connected to ground via a capacitance. Thus, the radiation electrode hardly generates a stray capacitance between the radiation electrode and a ground electrode disposed around the radiation electrode or between the radiation electrode and a component regarded as ground. Thus, the disclosed structure can suppress the deterioration of antenna characteristics due to a stray capacitance.

In addition, in the present disclosure, no feeding electrode is formed on the substrate of the surface mount antenna, but a feeding electrode is formed on a board on which the surface mount antenna is disposed. Thus, in the present disclosure, shared use of the surface mount antenna can be achieved. The reason for this is as follows.

A circuit configuration of a high-frequency circuit for radio communication to be electrically connected to the radiation electrode of the surface mount antenna depends on the model of radio communication device. Thus, a matching state between the radiation electrode and the high-frequency circuit depends on the model of a radio communication device or the like. Therefore, to obtain satisfactory matching between the radiation electrode and the high-frequency circuit, it is necessary to change the position of the feeding electrode with respect to the radiation electrode in accordance with the model of the radio communication device. Thus, when the feeding electrode is formed on the substrate of the surface mount antenna, it is necessary to change the design of the surface mount antenna for each model of the radio communication device.

On the other hand, in an antenna structure according to the present disclosure, a feeding electrode is disposed on a board on which a surface mount antenna is mounted, and the feeding electrode is not disposed on the substrate of the surface mount antenna. Thus, according to the present disclosure, when the model of the radio communication device is changed, it is only necessary to change the relative position of the feeding electrode on the board and no change in the design of the surface mount antenna is necessary. That is, in the antenna structure, the surface mount antenna can serve as a surface mount antenna common to a plurality of models of radio communication devices, and thus shared use of the surface mount antenna can be facilitated.

In addition, a resonant frequency of the radiation electrode can be adjusted or changed without a design change of the surface mount antenna, because of a configuration in which at least one reactance portion for adjusting the resonant frequency of the radiation electrode is provided on the board. For example, a capacitance or an inductance can be connected between ground and either end or both ends of the surface mount antenna. Thus, the configuration in which a reactance portion for adjusting the resonant frequency of the radiation electrode is provided on the board further facilitates shared use of the surface mount antenna.

In addition, the surface mount antenna is allowed to perform radio communication in a plurality of different frequency bands, by a configuration in which the radiation electrode has a plurality of antenna resonant modes with different resonant frequencies. This permits radio communication in a plurality of frequency bands without providing a plurality of antennas in a radio communication device. Therefore, a radio communication device provided with an antenna structure having a plurality of antenna resonant modes permits downsizing and cost reduction, as compared to the case where it is necessary to provide a plurality of antennas in the radio communication device.

In addition, with a configuration in which the feeding electrode is also operable as an antenna, not only the radiation electrode but also the feeding electrode can operate as an antenna. That is, the antenna structure according to the present disclosure in which the feeding electrode is also operable as an antenna permits radio communication in a plurality of different frequency bands, and thus multi-functionality of an antenna structure can be achieved. Accordingly, with the antenna structure of the present disclosure, downsizing and cost reduction of a radio communication device can be achieved.

Other features and advantages will become apparent from the following description of embodiments, which refers to the accompanying drawings.

### BRIEF DESCRIPTION OF THE DRAWINGS

FIG. 1 is a model diagram illustrating an antenna structure of a first embodiment.

FIG. 2a is a perspective view for describing an example of a surface mount antenna constituting the antenna structure illustrated in FIG. 1.

FIG. 2b is a schematic developed view of the surface mount antenna in FIG. 2a.

FIG. 2c is a schematic circuit diagram of the surface mount antenna in FIG. 2a.

FIG. 3a is a diagram for describing another example of an antenna structure for the first embodiment.

FIG. 3b is a diagram for describing a further example of an antenna structure.

FIG. 4a is a diagram for describing another configuration example of a radiation electrode.

FIG. 4b is a diagram for describing a further configuration example of a radiation electrode.

FIG. 4c is a diagram for describing yet another configuration example of a radiation electrode.

FIG. 5a is a diagram for describing an antenna structure of a second embodiment.

FIG. 5b is a diagram for describing another antenna structure of the second embodiment.

FIG. 6a is a diagram for describing an antenna structure of a third embodiment.

FIG. 6b is a diagram for describing an antenna structure of the third embodiment.

FIG. 7a is a perspective view for describing a further embodiment.

FIG. 7b is a perspective view for describing yet another embodiment.

FIG. 7c is a developed view for describing still another embodiment.

FIG. 8 is a diagram for describing an example of a conventional surface mount antenna.

FIG. 9a is a perspective view for describing another example of a conventional surface mount antenna.

FIG. 9b is a circuit diagram for describing the other example of a conventional surface mount antenna.

### DETAILED DESCRIPTION

### Reference Numerals

1 surface mount antenna

2 substrate

3 radiation electrode

4 ground connection electrode

6 circuit board

7 antenna structure

8 ground electrode

11 feeding electrode

12 high-frequency circuit

In the following, embodiments will be described on the basis of the drawings.

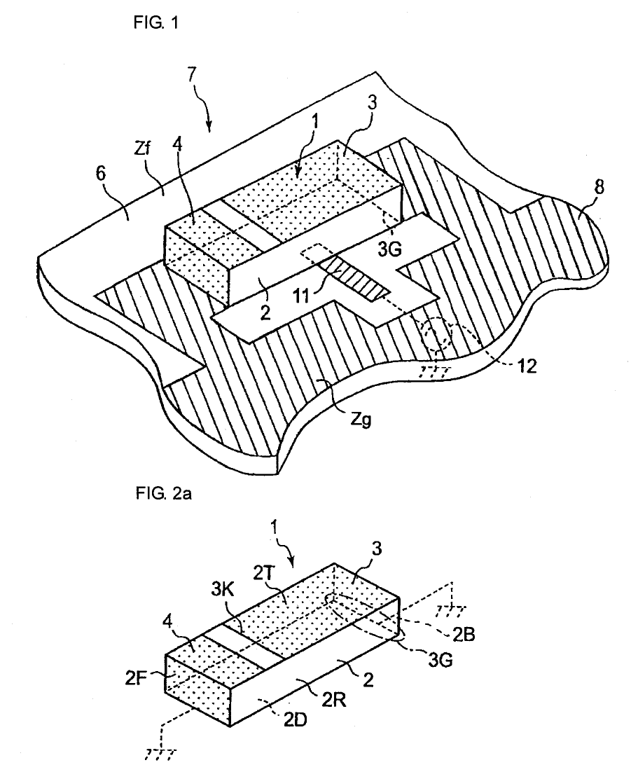

FIG. 1 schematically illustrates an antenna structure of a first embodiment. This antenna structure 7 of the first embodiment is composed of a surface mount antenna 1 mounted on a board 6. Note that the board 6 is, for example, a circuit board of a radio communication device which will be described below.

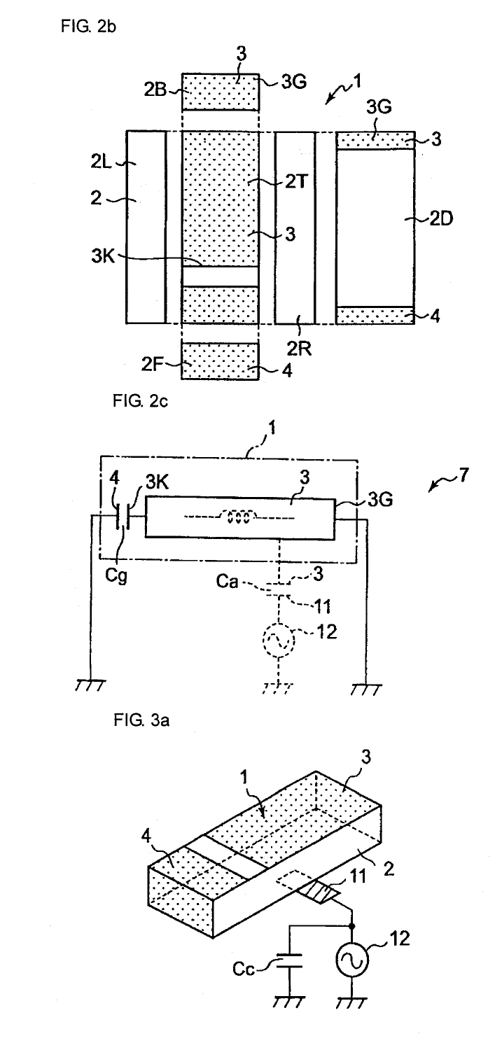

FIG. 2a illustrates the surface mount antenna extracted from FIG. 1 in a schematic perspective view. FIG. 2b is a schematic developed view of the surface mount antenna in FIG. 2a. This surface mount antenna 1 has a rectangular parallelepiped substrate 2 formed of, for example, a dielectric material. A radiation electrode 3 and a ground connection electrode 4 are formed on the substrate 2. In the example of FIG. 2a and FIG. 2b, the radiation electrode 3 extends from the bottom surface 2D side across the rear end surface 2B to the top surface 2T side of the substrate 2. This radiation electrode 3 is a λ/4 type radiation electrode. One end (end portion on the bottom surface 2D side) 3G of the radiation electrode 3 forms a ground connection portion to be connected to ground. The other end (end portion on the top surface 2T side) 3K of the radiation electrode 3 is an open end. Note that λ represents a wavelength of a radio wave for radio communication.

In addition, the ground connection electrode 4 extends from the bottom surface 2D side across a front end surface 2F to the top surface 2T side of the substrate 2. The leading end of the ground connection electrode 4 is arranged next to the open end 3K of the radiation electrode 3 with a space therebetween. In addition, the leading end of the ground connection electrode 4 is arranged at a position where a predetermined capacitance is provided between the open end 3K and the leading end. This ground connection electrode 4 is capacitively coupled with the open end 3K of the radiation electrode 3 to cause the open end 3K of the radiation electrode 3 to be connected to ground via a capacitance.

In the first embodiment, the surface mount antenna 1 is configured as described above. In addition, the surface mount antenna 1 has an equivalent circuit illustrated by solid lines in FIG. 2c. Thus, the resonant frequency of the radiation electrode 3 is mainly determined in relation to an inductance value of the radiation electrode 3 and a capacitance Cg between the open end 3K of the radiation electrode 3 and the ground connection electrode 4. With this arrangement, the surface mount antenna 1 is designed such that the radiation electrode 3 can have a predetermined resonant frequency. Specifically, in the design of the surface mount antenna 1, the physical length from the ground connection portion 3G to the open end 3K of the radiation electrode 3 which relates to the inductance value of the radiation electrode 3, the capacitance Cg between the open end 3K of the radiation electrode 3 and the ground connection electrode 4, and so forth, are associated with each other while the dielectric constant of the substrate 2 is taken into account.

As illustrated in FIG. 1, in the first embodiment, the surface mount antenna 1 is mounted on the board (circuit board) 6 of a radio communication device, for example, so as to constitute the antenna structure 7. A ground region Zg and a non-ground region Zf are provided on the circuit board 6. The ground region Zg is a region on which a ground electrode 8 is formed. The non-ground region Zf is a region on which the ground electrode 8 is not formed. In the antenna structure of the first embodiment, the surface mount antenna 1 is disposed across the non-ground region Zf on the circuit board 6. The ground connection portion 3G of the radiation electrode 3 at one end of the surface mount antenna 1 and the ground connection electrode 4 at the other end of the surface mount antenna 1 are arranged on the ground electrode 8 and attached by soldering or the like so as to be grounded.

Further, a feeding electrode 11 is formed on the non-ground region Zf of the circuit board 6. The feeding electrode 11 is electrically connected to a high-frequency circuit 12 of a radio communication device for radio communication. The feeding electrode 11 is formed for capacitively feeding a signal from the high-frequency circuit 12 to the radiation electrode 3 of the surface mount antenna 1. In the example of FIG. 1, a part of the feeding electrode 11 extends below the substrate 2 of the surface mount antenna 1 and is positioned opposite the radiation electrode 3 with a space therebetween. In the antenna structure 7 of the first embodiment, a section in the radiation electrode 3 to which the feeding electrode 11 capacitively feeds power (i.e., feeding section of the radiation electrode 3) is as follows. That is, the section is positioned between the ground connection portion 3G and the open end 3K, which provides satisfactory matching between the radiation electrode 3 and the high-frequency circuit 12.

The antenna structure 7 of the first embodiment has an equivalent circuit which includes a capacitance Ca indicated by dotted lines in addition to the equivalent circuit of the surface mount antenna 1 illustrated in FIG. 2c. This capacitance Ca is a capacitance generated by the feeding electrode 11 and the radiation electrode 3. In the configuration of the antenna structure 7 of the first embodiment, both the ends of the radiation electrode 3 of the surface mount antenna 1 are connected to ground. Therefore, the effect of the capacitance Ca on the resonant frequency of the radiation electrode 3 is small, and the capacitance Ca mainly affects matching between the radiation electrode 3 and the high-frequency circuit 12. Therefore, the capacitance Ca is set to be a value which provides satisfactory matching between the radiation electrode 3 and the high-frequency circuit 12 at a resonant frequency determined by the radiation electrode 3 and the capacitance Cg. The size and so forth of the feeding electrode 11 are determined such that the capacitance Ca has the predetermined value.

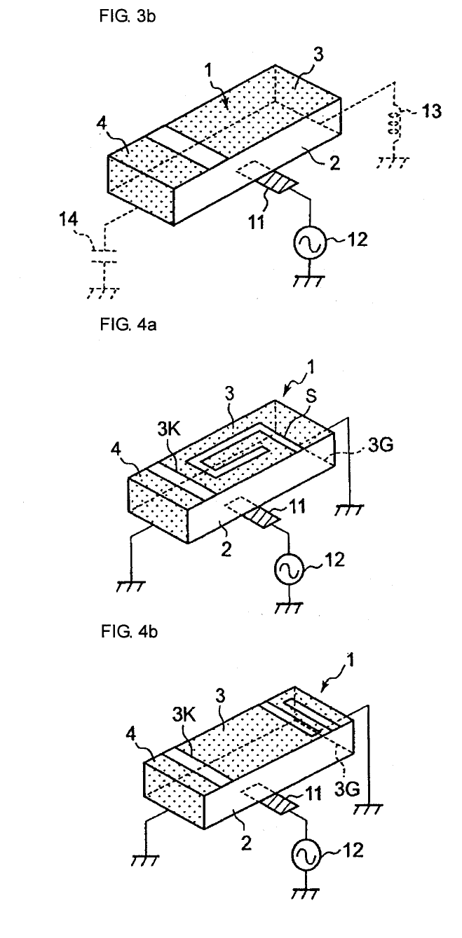

To achieve satisfactory matching between the radiation electrode 3 and the high-frequency circuit 12, the surface mount antenna 1 may be configured as illustrated in FIG. 3a. Specifically, the surface mount antenna 1 may have an electrical path connecting a point between the feeding electrode 11 and the high-frequency circuit 12 to ground, and a capacitance Cc for matching may be provided in the path.

When the surface mount antenna 1 is to be mounted on each of a plurality of models of radio communication devices, radio communication in a desired frequency band may be difficult using only the surface mount antenna 1. This is because the surface mount antenna 1 is not designed to be dedicated to a certain model of radio communication device among the models. In this case, radio communication in a desired frequency band can be enabled by providing, for example, a capacitor portion serving as a reactance portion or an inductor portion serving as a reactance portion on the circuit board 6, as described below.

For example, when radio communication in a predetermined frequency band using the surface mount antenna 1 alone is difficult due to a high resonant frequency, an inductor portion 13 is provided as illustrated by dotted lines in FIG. 3b. Specifically, the inductor portion 13 serving as a reactance portion is provided in series in a conductive path on the circuit board 6 for connecting the ground connection portion of the radiation electrode 3 and the ground electrode 8. With this arrangement, inductance components can be supplied to the radiation electrode 3, and thus the resonant frequency of the radiation electrode 3 can be lowered. Thus, an antenna structure for performing radio communication in a desired frequency band can be achieved, for example, by providing the inductor portion 13 having an inductance value for correcting the resonant frequency to be decreased by an excess of the resonant frequency of the surface mount antenna 1 with respect to an intended resonant frequency.

In addition, the resonant frequency of the radiation electrode 3 can also be adjusted by providing a capacitor portion 14, as illustrated by dotted lines in FIG. 3b. Specifically, a capacitance is supplied to the radiation electrode 3 by providing the capacitor portion 14 serving as a reactance portion in series in a conductive path on the circuit board 6 for connecting the ground connection electrode 4 and the ground electrode 8. The resonant frequency of the radiation electrode 3 can also be adjusted by supplying the capacitance 14 between the radiation electrode 3 and the ground electrode 8. That is, an antenna structure permitting radio communication in a desired frequency band can be achieved also by providing this capacitor portion 14.

Further, needless to say, both the inductor portion 13 and the capacitor portion 14 may be provided for performing radio communication in a desired frequency band. The inductor portion 13 or the capacitor portion 14 can be formed of electrical components (reactance elements) having an inductance or a capacitance. In addition, the inductor portion 13 and the capacitor portion 14 may be configured as conductor patterns formed on the circuit board 6. The inductor portion and the capacitor portion can be connected to either the electrode 3 or the electrode 4.

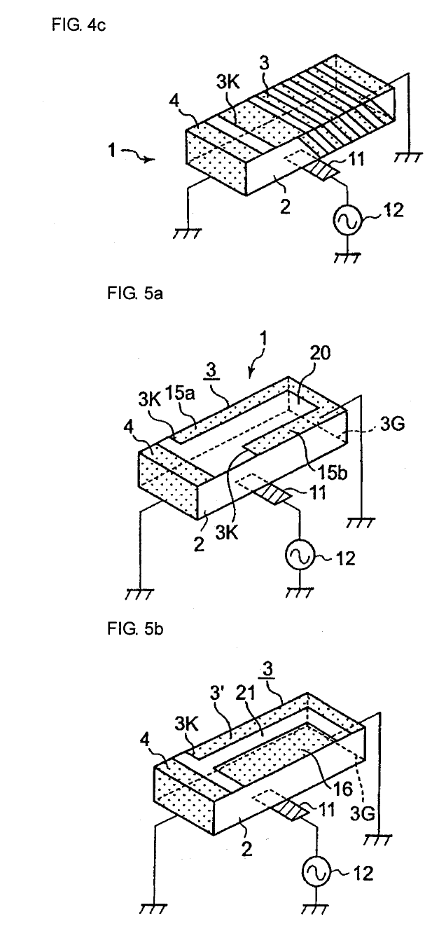

Note that while in the example illustrated in FIG. 1 to FIG. 3b, the radiation electrode 3 has a strip shape, the radiation electrode 3 may have another shape. For example, as illustrated in FIG. 4a, a slit S may be formed on the radiation electrode 3 such that the radiation electrode 3 has a spiral shape. In addition, a part of or the entire radiation electrode 3 may have a meander shape, as illustrated in FIG. 4b. Further, the radiation electrode 3 may have a helical shape, as illustrated in FIG. 4c.

The electrical length of the radiation electrode 3 having the shape illustrated in each of FIG. 4a to FIG. 4c can be larger than that of the radiation electrode 3 illustrated in FIG. 1. That is, the inductance value of the radiation electrode 3 having the shape illustrated in each of FIG. 4a to FIG. 4c can be larger than that of the radiation electrode 3 illustrated in FIG. 1. Thus, with the radiation electrode 3 having the shape illustrated in each of FIG. 4a to FIG. 4c, downsizing of the radiation electrode 3 and downsizing of the substrate 2 can be realized. Therefore, the radiation electrode 3 having the shape illustrated in each of FIG. 4a to FIG. 4c allows downsizing of the surface mount antenna 1 and the antenna structure 7 using the surface mount antenna 1.

In the following, a second embodiment will be described. In the description of the second embodiment, the same reference numerals are assigned to the same components as those in the first embodiment, and the redundant description thereof will be omitted.

In this second embodiment, a radiation electrode 3 has a plurality of antenna resonant modes with different resonant frequencies. An antenna structure 7 (not shown) is capable of radio communication in a plurality of different frequency bands. Various configurations may be possible to provide a plurality of antenna resonant modes to the radiation electrode 3, and any of such configurations may be employed. Examples of such configurations include a configuration illustrated in FIG. 5a and a configuration illustrated in FIG. 5b, for example.

In the example of FIG. 5a, the radiation electrode 3 is branched into plural portions (two, in the example of FIG. 5a) at a section between a ground connection portion 3G to an open-end 3K. In the radiation electrode 3, a plurality of branched radiation electrodes 15a and 15b are formed. In other words, a slit 20 extending from the open end 3K of the radiation electrode 3 toward the ground connection portion 3G is provided on the radiation electrode 3. This slit 20 provides the plural branched radiation electrodes 15a and 15b. For example, the branched radiation electrode 15a is configured to have a first antenna resonant mode in which resonance occurs at a predetermined resonant frequency. The branched radiation electrode 15b is configured to have a second antenna resonant mode with a resonant frequency higher than that in the first antenna resonant mode. With these radiation electrodes 15a and 15b, the radiation electrode 3 can have a plurality of antenna resonant modes.

In the example of FIG. 5b, the radiation electrode 3 has a main body 3′ and a floating electrode 16. One end of the main body 3′ is the ground connection portion 3G and the other end of the main body 3′ is the open end 3K. The radiation electrode 3 is configured so as to be excited at a predetermined frequency for radio communication to perform antenna operations. The floating electrode 16 is separated from the main body 3′ by a slit 21 formed on the radiation electrode 3. The floating electrode 16 is electromagnetically coupled with the main body 3′ and is electrically floating. This floating electrode 16 is configured to be excited at a predetermined frequency for radio communication which is different from the resonant frequency set at the main body 3′, to perform antenna operations. The main body 3′ and the floating electrode 16 allow the radiation electrode 3 to have a plurality of antenna resonant modes.

Configurations of the second embodiment other than the above-described configuration are similar to those of the first embodiment. In this second embodiment, the radiation electrode 3 has a plurality of antenna resonant modes with different resonant frequencies. Therefore, the surface mount antenna 1 and the antenna structure 7 having the surface mount antenna 1 of the second embodiment (not shown) can suppress a size increase and have increased further multi-functionality.

In the following, a third embodiment will be described. In the description of the third embodiment, the same reference numerals are assigned to the same components as those in the first and second embodiments, and the redundant description thereof will be omitted.

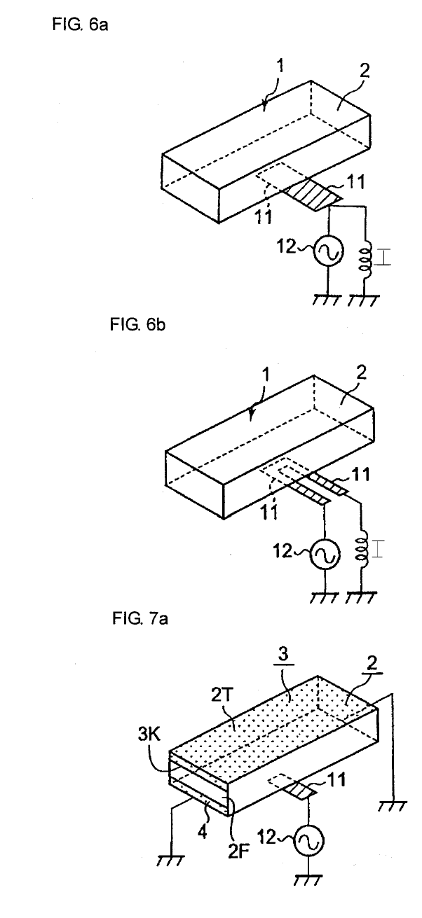

In an antenna structure 7 of the third embodiment (not shown), a feeding electrode 11 can also operate as an antenna. Specifically, the feeding electrode 11 has a predetermined frequency for radio communication as a resonant frequency to perform antenna operations. Various configurations may be possible for enabling the feeding electrode 11 to operate also as an antenna, and any of such configurations may be employed. In an example of such configurations, as illustrated in FIG. 6a, the feeding electrode 11 is configured as an inverted F antenna. In another example, as illustrated in FIG. 6b, the feeding electrode 11 has a shape of a loop antenna. An inductance I is provided between the feeding electrode 11 and ground. In FIG. 6a and FIG. 6b, illustration of a radiation electrode 3 and a ground connection electrode 4 on a substrate 2 is omitted.

Configurations of the third embodiment other than the above-described configuration are similar to those of the first and second embodiments. As in the case of the third embodiment, multi-functionality of the antenna structure 7 can be achieved by operating the feeding electrode 11 also as an antenna in the first and second embodiments. In particular, with the configuration having the surface mount antenna 1 with multi-functionality described in the second embodiment, if the feeding electrode 11 is operated also as an antenna, radio communication in an increased number of frequency bands can be realized. Therefore, with the configuration having the surface mount antenna 1 with multi-functionality described in the second embodiment, when the feeding electrode 11 is operated also as an antenna, the antenna structure 7 with further advanced multi-functionality can be provided.

In the following, a fourth embodiment will be described. The fourth embodiment relates to a radio communication device. In a radio communication device in the fourth embodiment, at least one of the antenna structures 7 described in the first to third embodiments is provided, in combination with a high-frequency circuit for radio communication. Other than this arrangement, various configurations may be applied to the radio communication device and any of such configurations may be employed, of which the description will also be omitted. In addition, the configurations of the surface mount antenna 1 and the antenna structure 7 of each of the first to third embodiments have been described above, and the description thereof will also be omitted.

Note that the present invention is not limited to the configurations according to the first to fourth embodiments, and other various embodiments may be applied to the present invention. For example, in each of the first to fourth embodiments, the surface mount antenna 1 has a rectangular parallelepiped shape. However, the substrate 2 may have the shape of a cylinder, a triangular prism, or a polygonal prism.

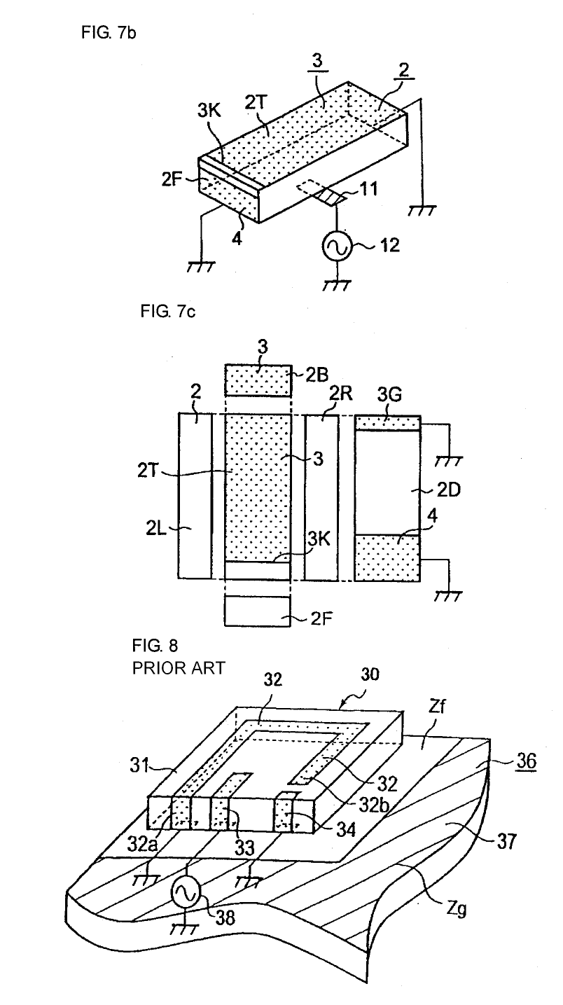

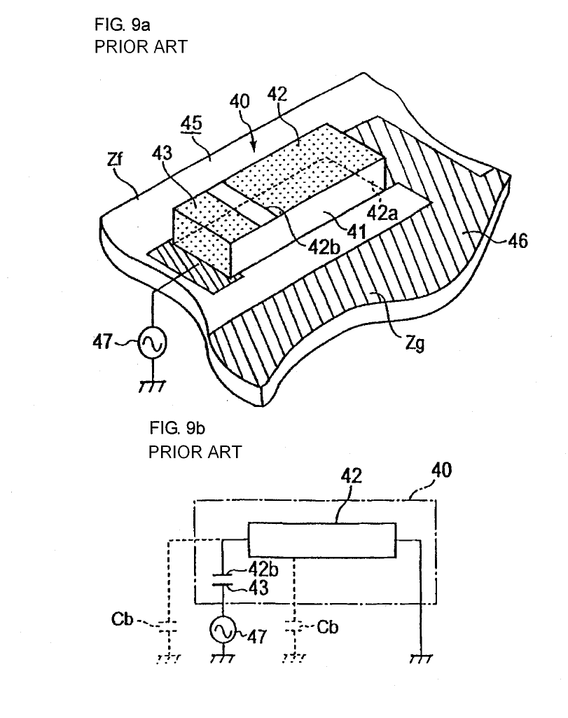

In addition, in each of the examples of FIG. 1 to FIG. 6b, the open end 3K of the radiation electrode 3 of the surface mount antenna 1 is disposed on the top surface 2T of the substrate 2. In addition, the ground connection electrode 4 extends from the front end surface 2F to the top surface 2T of the substrate 2 so that the leading edge is capacitively coupled with the open end 3K of the radiation electrode 3. However, for example, as illustrated in FIG. 7a, it may also be configured such that the open end 3K of the radiation electrode 3 is arranged on the front end surface 2K of the substrate 2 and the ground connection electrode 4 is capacitively coupled with the open end 3K of the radiation electrode 3 at the front end surface 2F of the substrate 2. In addition, a configuration illustrated in FIG. 7b may also be possible. In the configuration in FIG. 7b, the open end 3K of the radiation electrode 3 is arranged on the top surface 2T of the substrate 2, and the ground connection electrode 4 is disposed on the front end surface 2F of the substrate 2. Further, the open end 3K of the radiation electrode 3 on the top surface 2T and the ground connection electrode 4 on the front end surface 2F are capacitively coupled. Further, a configuration illustrated in a developed view in FIG. 7c may also be possible. In the configuration in FIG. 7c, the top surface 3K of the radiation electrode 3 is arranged on the top surface 2T of the substrate 2, and the ground connection electrode 4 is formed on the bottom surface 2D of the substrate 2. Further, the open end 3K of the radiation electrode 3 on the top surface 2T and the ground connection electrode 4 on the bottom surface 2D are capacitively coupled.

Furthermore, the radiation electrode 3 and the ground connection electrode 4 may be formed, partially or in its entirety, in the interior of the substrate 2. Thus, the positions of the open end 3K of the radiation electrode 3 and the ground connection electrode 4 are not restrictive and can be arbitrarily set in accordance with a predetermined required capacitance between the open end 3K of the radiation electrode 3 and the ground connection electrode 4.

Further, in each of the examples of antenna structures illustrated in FIG. 1 to FIG. 7c, a part of the feeding electrode 11 extends below the surface mount antenna 1. However, a part of the feeding electrode 11 may not extend below the surface mount antenna 1. Specifically, the feeding electrode 11 may be formed at any position which allows capacitive coupling with the radiation electrode 3 of the surface mount antenna 1 with a predetermined capacitance (i.e., capacitance for matching).

The present invention permits a single surface mount antenna to be mounted on a plurality of models of radio communication devices. Thus, the present invention is suitable as an antenna structure provided in a radio communication device such as a mobile phone, for which various models are required, and as the radio communication device.

Although particular embodiments have been described, many other variations and modifications and other uses will become apparent to those skilled in the art. Therefore, the present invention is not limited by the specific disclosure herein.

What is claimed is:

1. An antenna structure comprising:
a surface mount antenna comprising a radiation electrode performing an antenna operation, formed on a substrate; and
a board having a ground region having a ground electrode formed thereon and a non-ground region not having the ground region formed thereon,
the antenna structure having a configuration in which the surface mount antenna is mounted on the non-ground region of the board,
wherein
one end of the radiation electrode of the surface mount antenna is a ground connection portion to be grounded to the ground electrode of the board and the other end of the radiation electrode is an open end,
the radiation electrode has a feeding section capacitively fed with power at a position between the ground connection portion and the open end,
a ground connection electrode is formed on the substrate of the surface mount antenna, the ground connection electrode being capacitively coupled with the open end of the radiation electrode to electrically connect the open end of the radiation electrode to the ground electrode of the board via a capacitance, and
a feeding electrode is formed on the board, the feeding electrode capacitively feeding power to the feeding section of the radiation electrode of the surface mount antenna.

2. The antenna structure of claim 1, wherein a slit for providing a plurality of antenna resonant modes with different resonant frequencies is formed in the radiation electrode.

3. The antenna structure of claim 2, wherein the feeding electrode has a predetermined resonant frequency for communication and is also operable as an antenna.

4. The antenna structure of claim 1, wherein the feeding electrode has a predetermined resonant frequency for communication and is also operable as an antenna.

5. The antenna structure of any one of claim 1 to claim 4, wherein a conductive path for connecting the ground connection portion of the radiation electrode to the ground electrode of the board is provided on the board, and a reactance for controlling a resonant frequency of the radiation electrode is disposed in the conductive path.

6. The antenna structure of any one of claim 1 to claim 4, wherein a conductive path for connecting the ground connection electrode of the surface mount antenna to the ground electrode of the board is provided on the board, and a reactance for controlling a resonant frequency of the radiation electrode is disposed in the conductive path.

7. A radio communication device comprising a high-frequency circuit for radio communication at one or more communication frequency; and
an antenna structure comprising:
a surface mount antenna a radiation electrode performing an antenna operation, formed on a substrate; and
a board having a ground region having a ground electrode formed thereon and a non-ground region not having the ground region formed thereon,
the antenna structure having a configuration in which the surface mount antenna is mounted on the non-ground region of the board,
wherein
one end of the radiation electrode of the surface mount antenna is a ground connection portion to be grounded to the ground electrode of the board and the other end of the radiation electrode is an open end,
the radiation electrode has a feeding section capacitively fed with power at a position between the ground connection portion and the open end,
a ground connection electrode is formed on the substrate of the surface mount antenna, the ground connection electrode being capacitively coupled with the open end of the radiation electrode to electrically connect the open end of the radiation electrode to the ground electrode of the board via a capacitance, and
a feeding electrode is formed on the board, the feeding electrode capacitively feeding power to the feeding section of the radiation electrode of the surface mount antenna.

8. The antenna structure of claim 7, wherein a slit for providing a plurality of antenna resonant modes with different resonant frequencies corresponding to said one or more communication frequency is formed in the radiation electrode.

9. The antenna structure of claim 8, wherein the feeding electrode has a predetermined resonant frequency for communication corresponding to said one or more communication frequency and is also operable as an antenna.

10. The antenna structure of claim 7, wherein the feeding electrode has a predetermined resonant frequency for communication corresponding to said one or more communication frequency and is also operable as an antenna.
